(19) United States
(12) Patent Application Publication
(10) Pub. No.: US 2026/0030580 A1
(43) Pub. Date: Jan. 29, 2026

(54) SYSTEM AND METHOD OF ESTIMATING RISK FOR A PLURALITY OF ASSETS

(71) Applicant: JANA Corporation, Aurora (CA)

(72) Inventors: William Luff, Aurora (CA); Ashley Ee, Aurora (CA); Christelle Ah Knit, Aurora (CA)

(21) Appl. No.: 18/782,092

(22) Filed: Jul. 24, 2024

(51) Int. Cl. G06Q 10/0635; G06Q 10/067

(52) U.S. Cl. CPC G06Q 10/0635; G06Q 10/067; G06Q 50/06

(57) ABSTRACT

A system and method for forecasting failure in a plurality of assets wherein the system comprises one or more computing devices connected to a server through a network, wherein the server comprises a memory that stores reusable group attribute values, and one or more processors coupled to the memory. The one or more processors comprise program instructions that when executed, cause the one or more processors to forecast one or more failure rates for said assets based on a hazard model. The method comprises identifying a subgroup of assets and attributes of a specific plurality of assets and attributes corresponding to a grouped attribute combination, retrieving reusable grouped attribute values from the memory, and replacing a process of evaluating the subgroup of assets and attributes according to the hazard model, with the retrieved reusable grouped attribute values.

### FIELD OF THE DISCLOSURE

The present disclosure relates to the field of data processing systems and techniques, and in particular, to a system and method of data aggregation.

### BACKGROUND

The evolving technological landscape has driven companies and organizations in various industries to focus on making data-driven decisions by harnessing large amounts of data and further processing it to extract important insights. From identifying different inputs, transforming the data and analyzing it thereafter, performing this task can be quite complex and time-consuming. Hence, there is a need for a more efficient approach to handle copious amounts of data without compromising the quality of the processed outputs.

One such field that deals with a multitude of data is that of pipeline operations as vast networks of these linear infrastructures are found worldwide. They commonly channel important utilities such as oil, natural gas and related products across cities, provinces, and even countries. Since they are a means of delivering key energy resources that society relies on in the modern age, it is important to ensure that they are well-maintained to optimize operations and identify any potential risks and issues so they can be immediately attended to. As such, advanced data processing techniques are required to improve operational efficiency, safeguarding the integrity of pipeline infrastructures.

This background information is provided to reveal information believed by the applicant to be of possible relevance. No admission is necessarily intended, nor should be construed, that any of the preceding information constitutes prior art or forms part of the general common knowledge in the relevant art.

### BRIEF SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

The object of present disclosure is a system and method of estimating risk for a plurality of assets. Since there can be large amounts of data involved in computing output values in relation to the likelihood of failure especially for pipelines and other linear infrastructure, there is a need for an optimized method of processing the data to make it more streamlined.

In accordance with one aspect, there is provided a computer-implemented method for forecasting failure in a plurality of assets, the method comprising: grouping data associated with a plurality of attributes and the plurality of assets according to at least one grouped attribute combination which corresponds to at least one sub-portion of a hazard model for said assets; evaluating the at least one sub-portion of the hazard model using the data associated with the plurality of attributes and the plurality of assets of said at least one grouped attribute combination to generate one or more respective reusable grouped attribute values; storing said reusable grouped attribute values in a memory; and forecasting one or more failure rates of said plurality of assets with use of the hazard model and the data associated with a specific plurality of assets and attributes, including: identifying a subgroup of assets and attributes of the specific plurality of assets and attributes corresponding to a grouped attribute combination; retrieving the reusable grouped attribute values corresponding to the grouped attribute combination from the memory; and replacing a process of evaluating the subgroup of assets and attributes according to the hazard model, with the retrieved reusable grouped attribute values.

In some embodiments, the plurality of assets comprise one or more linear infrastructures.

In some embodiments, the plurality of attributes comprise historical data and physical characteristics of said assets.

In some embodiments, the historical data of said assets include incident reports and maintenance records.

In some embodiments, the hazard model is based on a variation of a Weibull proportional hazard model.

In some embodiments, retrieving the reusable grouped attribute value involves identification of a unique identifier.

In some embodiments, the method further comprises receiving data associated with a plurality of attributes of said assets prior to grouping the data associated with the plurality of attributes and the plurality of assets.

In some embodiments, the method further comprises deriving one or more risk assessment values based on the failure rate of said assets, displaying said risk assessment values in a graphical user interface.

In accordance with another aspect, there is provided a system for forecasting failure in a plurality of assets, the system comprising: one or more computing devices connected to a server through a network, wherein the server comprises: a memory that stores reusable group attribute values; and one or more processors coupled to the memory comprising program instructions, wherein the program instructions are executable by the one or more processors to forecast one or more failure rates for said plurality of assets with use of a hazard model based on data from a plurality of attributes and the plurality of assets.

In some embodiments, the network involves cloud computing infrastructure.

In some embodiments, the plurality of assets comprise one or more linear infrastructures.

In some embodiments, the plurality of attributes comprise historical data and physical characteristics of said assets.

In some embodiments, the historical data of said assets include incident reports and maintenance records.

In some embodiments, the hazard model is based on a variation of a Weibull proportional hazard model.

In some embodiments, the one or more processors generates and assigns unique identifiers for attribute values for said assets.

In accordance with another aspect, there is provided a non-transitory computer-readable medium storing program instructions, that when executed, cause one or more processors to perform operations comprising: grouping data associated with a plurality of attributes and a plurality of assets according to at least one grouped attribute combination which corresponds to at least one sub-portion of a hazard model for said assets; evaluating the at least one sub-portion of the hazard model using the data associated with the plurality of attributes and the plurality of assets of said at least one grouped attribute combination to generate one or more respective reusable grouped attribute values; storing said reusable grouped attribute values in a memory; and forecasting one or more failure rates of said plurality of assets with use of the hazard model and the data associated with a specific plurality of assets and attributes, including: identifying a subgroup of assets and attributes of the specific plurality of assets and attributes corresponding to a grouped attribute combination; retrieving the reusable grouped attribute values corresponding to the grouped attribute combination from the memory; and replacing a process of evaluating the subgroup of assets and attributes according to the hazard model, with the retrieved reusable grouped attribute values.

In some embodiments, the non-transitory computer-readable medium further comprises receiving data associated with the plurality of attributes of said assets prior to grouping the data associated with the plurality of attributes and the plurality of assets.

In some embodiments, the program instructions further comprise deriving one or more risk assessment values based on the one or more failure rates of said assets, displaying said risk assessment values in a graphical user interface.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a variation of the Weibull Proportional Hazard Model, in accordance with one embodiment;

FIG. 2 is a flow chart illustrating a strategy of grouping calculations based on a hazard model, in accordance with one embodiment;

FIG. 3 is a flow chart illustrating a process of integrating reusable attribute values when running calculations using a hazard model, in accordance with one embodiment; and

FIG. 4 is a schematic diagram of a computer system used to estimate risk for a plurality of assets, in accordance with one embodiment.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Large data sets have the potential to provide comprehensive and reliable analyses, but they also present challenges related to computational infrastructure including the use of increased processing power and time. Especially in the field of managing natural gas pipelines and determining the risks associated with it, the volume of data can be immense, and transformation of this data can be a complex process. Part of the reason for its time-consuming nature and demand for processing power is due to extensive computations required to handle different data sets. Therefore, a more efficient approach to run a multitude of calculations is needed.

In accordance with different embodiments, a system and method of estimating risk for a plurality of assets is presented to address the aforementioned challenges. It not only reduces time and cost in performing calculations, but also ensures that data integrity is maintained. The embodiments herein describe in detail the use of the system and method to assess risk as it relates to natural gas pipelines. However, the method is also applicable to other types of utilities and linear commodities such as liquid pipelines, transportation networks, and electrical infrastructure. Furthermore, the method can also be adapted to facility-type systems such as power plants, water treatment stations, and gas storage facilities.

The Weibull Proportional Hazard Model is a statistical model widely used across various industries to conduct analyses that include reliability and survival modeling, among others. It has also been adopted to account for different types of parameters to fit several applications. In accordance with different embodiments, a generalized form of the Weibull Proportional Hazard model 110 used as a basis of processing data is presented in Equation 1.

$$h ( t ) = \frac{β}{η} {( \frac{t - {t}_{0}}{η} )}^{β - 1} {e}^{\vec{z} \cdot \vec{γ}} \qquad Equation l$$

However, additional factors are often taken into account in the exponential component of the Weibull Proportional Hazard Model as a natural log of the sum of several values as shown in Equation 2.

$$h ( t ) = \frac{β}{η} {( \frac{t - {t}_{0}}{η} )}^{β - 1} {e}^{\vec{z} \cdot \vec{γ} + l n ( {A}_{1} {B}_{1} + {A}_{2} {B}_{2} + … + {A}_{n} {B}_{n} )} \qquad Equation 2$$

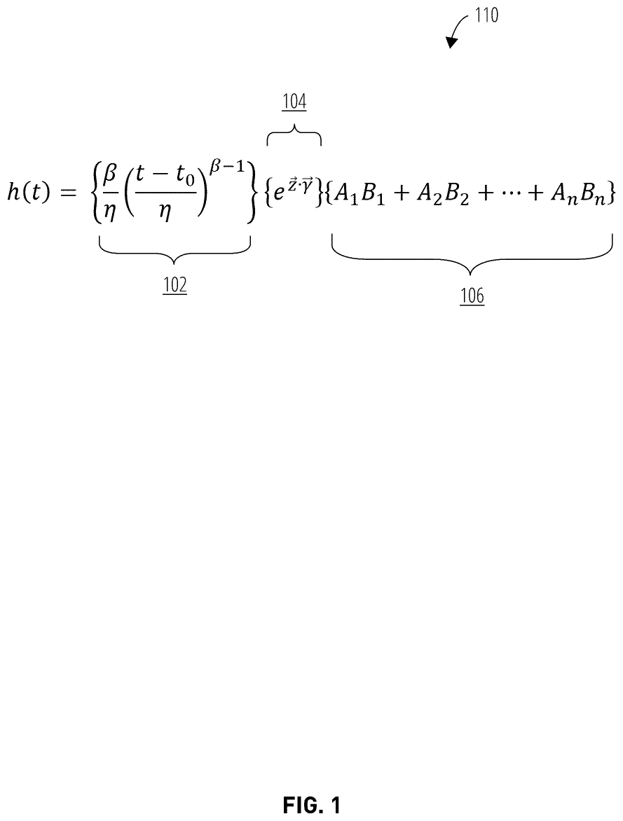

A more simplified version of this model accounting for the additional factor is presented in FIG. 1 as the natural log is removed from the equation. This model is used as a means to perform quantitative risk analysis and calculate the likelihood of failure for linear infrastructure for each asset among a plurality of assets (i.e., particular segments of pipelines such as mainlines, service branches and valves, and other linear infrastructure). More specifically, FIG. 1 illustrates a variation of the Weibull Proportional Hazard Model 110 wherein the equation is segmented into three distinct sub-portions or components shown as multiplied terms according to a preferred embodiment of the present disclosure. The components include a time component 102, multiplicative component 104 and an exponential component 106 that are varied independently. Other additional components, factors and parameters may be included as needed. Risk can be defined as the likelihood of failure multiplied by the consequence of failure. As such, forecasting failure using the Weibull Proportional Hazard Model 110 is a useful tool especially in the natural gas pipeline industry to manage resources, meet regulatory requirements, and minimize the impact of failure as some of these consequences can include repair fees, environmental and regulatory fines, as well as health and safety costs due to injury or death.

In accordance with an embodiment of the present disclosure, large data sets from databases, including, but not limited to relational databases, as well as publicly available gas industry, environmental and census data are gathered to execute a quantitative risk assessment in a gas distribution pipeline network. Some of the historical data may be gathered from incident reports or previous maintenance records of pipelines. The Weibull Proportional Hazard Model 110 is arranged into different sub-portions or components: the time component 102, multiplicative component 104, and exponential component 106, to separate data input combinations of attributes that are consistently factored into the equation. More specifically, the combinations are formed by aggregating a plurality of equation variables that share the same data values to represent input attributes, including physical pipeline characteristics. Especially over large groupings of assets over a given area, several data values under each component remain constant. In this case, a database key or unique hash is used to identify and combine the matching values of data. Similarly, the data outputs for each portion are marked with unique identifiers, allowing the output values to be integrated in subsequent calculations for other assets. Due to the structure in which data is combined, computations for these data inputs are not required to be rerun as they can appear multiple times in a large dataset.

In many cases, the hazard model 110 is not time-dependent since the time component 102 may often be found to be constant (β=1) regardless of asset age. Additionally, majority of assets may have the same multiplicative component 104 since they share the same values for the z vector. As such, calculations can be conducted once over a group of assets that share the same time component 102 and multiplicative component 104 where the results are stored for similar subsequent calculations. Hence, the complexity of the hazard model 110 collapses since calculations to determine the likelihood of failure of each asset would often solely depend on the additional factors that are taken into account in the exponential component 106. In accordance with another embodiment, if only the factors either under the multiplicative component 104 or time component 102 are constant over a group of assets, each component may be calculated by reusing previously calculated values stored in a memory. The calculations may also be run for the first time where the results are stored, ensuring that any duplicate values are not included. Through this approach, it is presumed that not all risk values per asset are stored as only those that can be reused are retained for any future applicable queries. By conducting computations using specific groupings of variables as described, users can run more calculations in a shorter time frame compared to scenarios without grouping. In other words, the processing power, time, and other computational resources required to run the task are considerably reduced, especially when the risk of failure per asset is calculated over a large area covering clusters of similar assets. Advantageously, the cost to host the application performing the calculations may be significantly reduced as well.

An exemplary general scenario is given wherein the likelihood of failure for 10 assets is to be considered in a calculation to measure risk. A typical approach would be to run the calculation 10 times, with each input processed once. However, by way of a non-limiting example, the 10 assets can be grouped into 3 assets with A data combinations, 5 assets with B data combinations and 2 assets with C data combinations. By doing so, it would simply allow for 3 calculations to be run with A, B and C combinations as they are applied to all 10 assets. To provide additional understanding, a sample scenario using the model in relation to the likelihood of failure of vehicles used in pipeline operations is presented in Equation 3.

$$h ( t ) = \frac{1}{η} {e}^{( {z}_{1} \cdot {γ}_{1} + {z}_{2} \cdot {γ}_{2} + … + {z}_{n} \cdot {γ}_{n} )} ( {A}_{1} {B}_{1} + {A}_{2} {B}_{2} + … + {A}_{n} {B}_{n} ) \qquad Equation 3$$

Using the above model, exemplary values for each parameter of the model are assigned to three assets as shown table 1 below.

TABLE 1
Exemplary Asset Values for Each Model Parameter in Equation 3.

| Parameter | Asset 1 Value | Asset 2 Value | Asset 3 Value |
|---|---|---|---|
| γ₁ | 30 | 30 | 30 |
| γ₂ | Plastic | Plastic | Cast Iron |
| B₁ | 39.235 | 67.3886 | 72.0922 |
| B₂ | 2 | 1 | 1 |
| B₃ | 1 | 1 | 2 |
| B₄ | 1 | 2 | 1 |
| B₅ | 0 | 0 | 0 |

Once the corresponding values of the various parameters of the model as presented above are entered as inputs into the model, the calculated results for each of the three distinct components of the model, as well as the overall likelihood of failure (e.g., leak rate) would be the following:

TABLE 2
Exemplary Resulting Asset Values Based
on Each Component of the Hazard model.

| Component Value | Asset 1 | Asset 2 | Asset 3 |
|---|---|---|---|
| Time component | 3.679e−07 | 3.679e−07 | 3.679e−07 |
| Multiplicative component | 8383.326 | 8383.326 | 14285.495 |
| Exponential factor component | 45.424 | 72.578 | 81.470 |
| Leak Rate (product of above | 1.40E−01 | 2.24E−01 | 4.28E−01 |
| three rows) | | | |

Based on the results of the calculations of the exemplary scenario above, the time component of all three assets is identical and the multiplicative components of asset 1 and asset 2 are found to be equivalent to each other as well. In this case, there is no difference in the calculated result between the time component 102 and multiplicative component 104 of assets 1 and 2, thereby reducing the number of calculations needed to calculate leak rates for all three assets. Overall, the number of dot products to be calculated for the multiplicative component 104 is reduced from three to two since only 2 types of materials are considered. This results in a significant reduction in time and computational resources required by several orders of magnitude. In an exemplary calculation considering a total asset count of 5×10⁶ assets, the calculated speed-up in processing time was about 30 times faster.

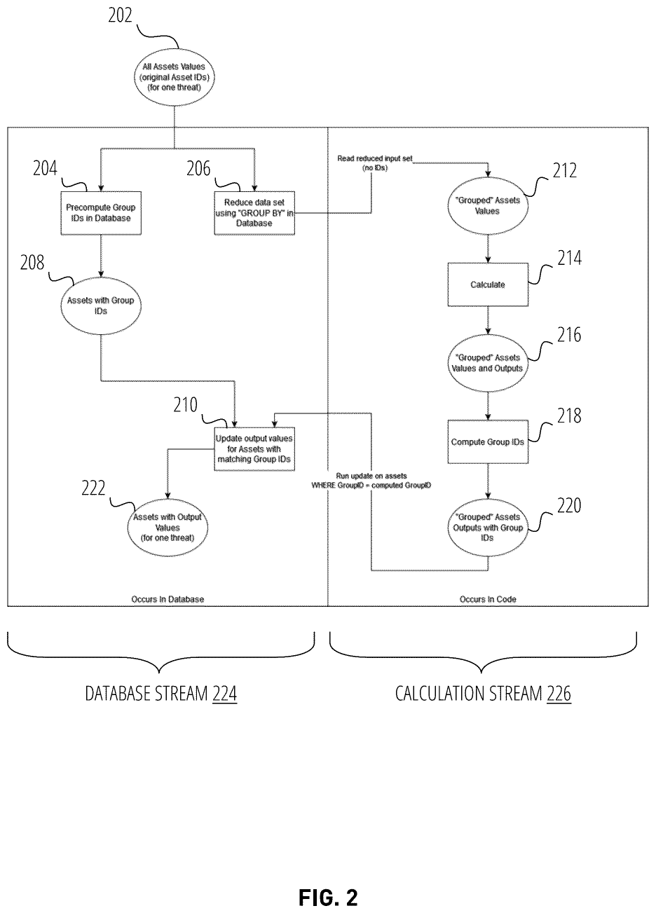

As illustrated in FIG. 2, a grouping strategy to assess risk for one threat covering a plurality of assets is presented. The grouping strategy is applied to each component of the hazard model 110 and is ultimately used to reduce the amount of asset data sent to a cloud computing network for processing. Data sets from publicly available gas industry, environmental and census data are gathered where each asset has corresponding values 202. Once a list of attributes is collected for each asset, the data may be processed through a database stream 224 and a calculation stream 226. For the database stream 224, an output table is prepared with a list of attributes for each asset. Once the asset values are in the database, group identifiers are precomputed 204 where each asset is tagged with a group identifier 208 based on the input values associated with each asset. The output value fields for each asset in the prepared output table are then left empty or null as the resulting values to be input in these fields are derived from the calculation stream 226. Essentially, the calculation stream 226 is run by a code which reduces the data set by retrieving distinct and unique sets of input attribute values from all assets. By way of a non-limiting example, the reduction of selected input attribute values is conducted in a similar manner by which a GROUP BY clause can function in SQL 206 (e.g., SELECT [threat attributes] from AssetTable GROUP BY [threat attributes]). After retrieving and grouping the input attribute values 212, calculations are performed 214 where the unique sets of input values are entered into the respective components of the Weibull Proportional Hazard model 110 as shown in FIG. 1. The calculations result in values corresponding to the grouped assets 216. A group hash for each unique set of values are generated 218 wherein the respective outputs for the grouped assets are tagged with a group identifier thereafter 220. An update is then performed on all assets on the output table to ensure that the output value fields are simultaneously classified and organized based on their group identifiers, and that the assets with matching group identifiers are aggregated together 210 (e.g., UPDATE OutputTable SET [threat attributes]=[output values] WHERE GroupID=[computed GroupID]). As a result, assets with output values 222 are arranged in a tabular format, ready to be used as a basis for further risk analysis. By doing so, the output values are set to be distributed to the ungrouped assets as needed. In any case, there is no requirement for group identifiers to be sent to the cloud computing network if the method of generating the group identifiers is deterministic, a function of the threat ID and input values, and produces no collisions in the domain (e.g., a unique hash of the input data). Provided that the hash can be computed independently in the database and code, it can be derived when necessary.

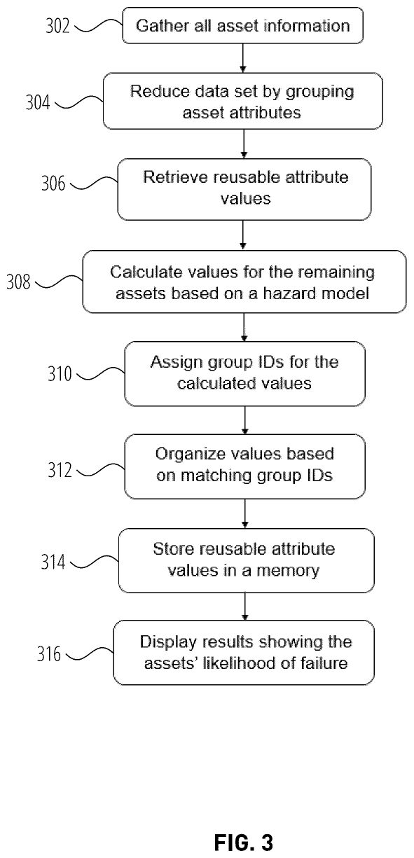

According to one embodiment of the present disclosure, FIG. 3 presents a process of integrating reusable attribute values when running calculations using the Weibull Proportional Hazard model 110. Similar to the calculation stream 226 described above, asset information, including all their attributes, are first gathered 302 from publicly available gas industry, environmental and census data. The gathered data is then processed by first reducing the data in which the asset attributes are grouped together 304. Grouping is performed in a similar manner by which a GROUP BY clause can function in SQL as those that have the same input values are combined. However, prior to conducting any calculations, reusable attribute values from previously processed assets are retrieved 306 based on their unique identifiers. Since not all asset attributes can be grouped, calculations based on the hazard model 110 are performed on the remaining assets 308. Consequently, group identifiers are assigned for the calculated values 310 and the calculated values are organized based on matching group identifiers 312. If there are any reusable attribute values, they are stored in a memory 314. In any case, the results showing the likelihood of failure of the assets (e.g., leak rate) are displayed 316 in a graphical user interface.

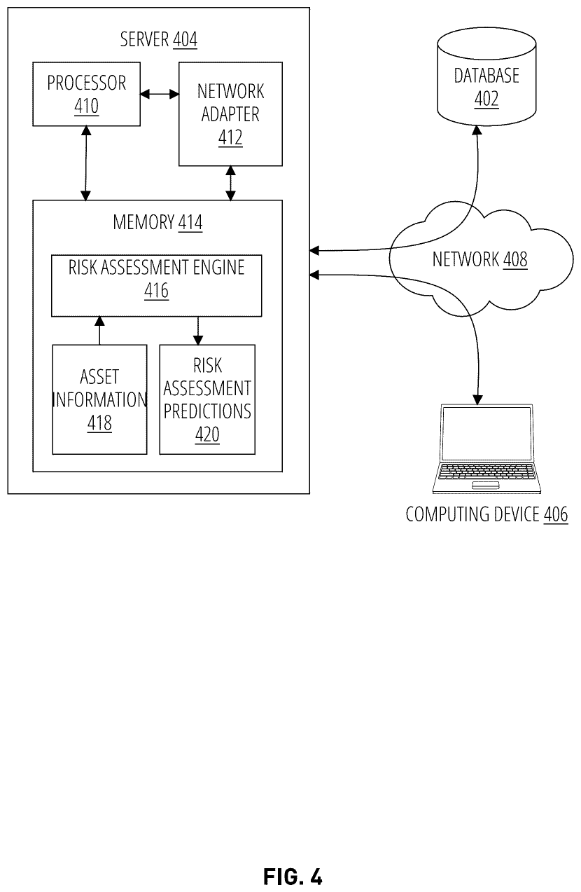

As illustrated in FIG. 4, a system for estimating risk for a plurality of assets is presented. According to an embodiment of the present disclosure, the system includes data sets in a database 402 wherein information of a plurality of assets, including their attributes are organized in tabular formats. The database 402, along with a computing device 406 are connected to a server 404 through a cloud computing network 408, wherein the connection between the aforementioned units facilitated by a network adapter 412. A query is entered into the user interface of the computing device 406 to generate the likelihood of failure for each asset against a particular threat (e.g., leak rate). The memory 414 is configured to receive a plurality of data inputs from at least one data set from the database relating to asset information 418, and execute calculations based on a set of computer-based program instructions embedded in the risk assessment engine 416 within the memory 414. The program instructions in the risk assessment engine 416 are set to transform asset information 418 to risk assessment predictions 420 through a processor 410 based on distinct components of the Weibull Proportional Hazard model 110, while any reusable attribute values are stored in the memory 414. The resulting attribute values are tagged with unique identifiers that allow for duplicate values for each attribute to be grouped together. By organizing the resulting values as such, some grouped attribute values can be reused for subsequent runs of risk assessment predictions 420, especially when the assets to be covered have similar attributes. The output data from the risk assessment system is used to predict the likelihood of failure of a plurality of assets and possible consequences of failure as it provides insights for each case (e.g., type of material that is most likely to cause leakage).

The steps of the methods described herein may be achieved via an appropriate programmable processing device that executes software, or stored instructions. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments discussed above and appreciated by those skilled in the computer and software arts. Appropriate software can be readily prepared by programmers of ordinary skill based on the teachings of the exemplary embodiments, as is appreciated by those skilled in the software arts. In addition, the devices and subsystems of the exemplary embodiments can be implemented by the preparation of application-specific integrated circuits, as is appreciated by those skilled in the electrical arts. Thus, the exemplary embodiments are not limited to any specific combination of hardware circuitry and/or software.

Stored on any one or a combination of computer readable media, the exemplary embodiments of the present disclosure may include software for controlling the devices and subsystems of the exemplary embodiments, for driving the devices and subsystems of the exemplary embodiments, for processing data and signals, for enabling the devices and subsystems of the exemplary embodiments to interact with a human user or the like. Such software can include, but is not limited to, device drivers, firmware, operating systems, development tools, applications software, and the like. Such computer-readable media further can include the computer program product of an embodiment of the present disclosure for preforming all or a portion (if processing is distributed) of the processing performed in implementations. Computer code devices of the exemplary embodiments of the present disclosure can include any suitable interpretable or executable code mechanism, including but not limited to scripts, interpretable programs, dynamic link libraries (DLLs), complete executable programs and the like.

Common forms of computer-readable media may include, for example, magnetic disks, flash memory, RAM, a PROM, an EPROM, a FLASH-EPROM, or any other suitable memory chip or medium from which a computer or processor can read.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A computer-implemented method for forecasting failure in a plurality of assets, the method comprising:
grouping data associated with a plurality of attributes and the plurality of assets according to at least one grouped attribute combination which corresponds to at least one sub-portion of a hazard model for said assets;
evaluating the at least one sub-portion of the hazard model using the data associated with the plurality of attributes and the plurality of assets of said at least one grouped attribute combination to generate one or more respective reusable grouped attribute values;
storing said reusable grouped attribute values in a memory; and
forecasting one or more failure rates of said plurality of assets with use of the hazard model and the data associated with a specific plurality of assets and attributes, including:
identifying a subgroup of assets and attributes of the specific plurality of assets and attributes corresponding to a grouped attribute combination;
retrieving the reusable grouped attribute values corresponding to the grouped attribute combination from the memory; and
replacing a process of evaluating the subgroup of assets and attributes according to the hazard model, with the retrieved reusable grouped attribute values.

2. The computer-implemented method of claim 1 wherein the plurality of assets comprise one or more linear infrastructures.

3. The computer-implemented method of claim 1 wherein the plurality of attributes comprise historical data and physical characteristics of said assets.

4. The computer-implemented method of claim 3 wherein the historical data of said assets include incident reports and maintenance records.

5. The computer-implemented method of claim 1 wherein the hazard model is based on a variation of a Weibull proportional hazard model.

6. The computer-implemented method of claim 1 wherein retrieving the reusable grouped attribute value involves identification of a unique identifier.

7. The computer-implemented method of claim 1 further comprising receiving data associated with a plurality of attributes of said assets prior to grouping the data associated with the plurality of attributes and the plurality of assets.

8. The computer-implemented method of claim 1 further comprising deriving one or more risk assessment values based on the failure rate of said assets, displaying said risk assessment values in a graphical user interface.

9. A system for forecasting failure in a plurality of assets, the system comprising:
one or more computing devices connected to a server through a network, wherein the server comprises:
a memory that stores reusable group attribute values; and
one or more processors coupled to the memory comprising program instructions, wherein the program instructions are executable by the one or more processors to forecast one or more failure rates for said plurality of assets with use of a hazard model based on data from a plurality of attributes and the plurality of assets.

10. The system of claim 9 wherein the network involves cloud computing infrastructure.

11. The system of claim 9 wherein the plurality of assets comprise one or more linear infrastructures.

12. The system of claim 9 wherein the plurality of attributes comprise historical data and physical characteristics of said assets.

13. The system of claim 12 wherein the historical data of said assets include incident reports and maintenance records.

14. The system of claim 9 wherein the hazard model is based on a variation of a Weibull proportional hazard model.

15. The system of claim 9 wherein the one or more processors generates and assigns unique identifiers for attribute values for said assets.

16. A non-transitory computer-readable medium storing program instructions, that when executed, cause one or more processors to perform operations comprising:
grouping data associated with a plurality of attributes and a plurality of assets according to at least one grouped attribute combination which corresponds to at least one sub-portion of a hazard model for said assets;
evaluating the at least one sub-portion of the hazard model using the data associated with the plurality of attributes and the plurality of assets of said at least one grouped attribute combination to generate one or more respective reusable grouped attribute values;
storing said reusable grouped attribute values in a memory; and
forecasting one or more failure rates of said plurality of assets with use of the hazard model and the data associated with a specific plurality of assets and attributes, including:
identifying a subgroup of assets and attributes of the specific plurality of assets and attributes corresponding to a grouped attribute combination;
retrieving the reusable grouped attribute values corresponding to the grouped attribute combination from the memory; and
replacing a process of evaluating the subgroup of assets and attributes according to the hazard model, with the retrieved reusable grouped attribute values.

17. The non-transitory computer-readable medium of claim 16 further comprising receiving data associated with the plurality of attributes of said assets prior to grouping the data associated with the plurality of attributes and the plurality of assets.

18. The non-transitory computer-readable medium of claim 16 wherein the program instructions further comprise deriving one or more risk assessment values based on the one or more failure rates of said assets, displaying said risk assessment values in a graphical user interface.
